(19) United States
(12) Patent Application Publication
(10) Pub. No.: US 2025/0230316 A1
(43) Pub. Date: Jul. 17, 2025

(54) THERMOPLASTIC COMPOSITIONS AND USES THEREOF

(71) Applicant: SHPP GLOBAL TECHNOLOGIES B.V., Bergen op Zoom (NL)

(72) Inventors: Laura Mely RAMIREZ, Evansville, IN (US); Wei ZHAO, Evansville, IN (US)

(21) Appl. No.: 18/699,040

(22) PCT Filed: Oct. 6, 2022
(86) PCT No.: PCT/IB2022/059570

§ 371 Date: Apr. 5, 2024

(30) Foreign Application Priority Data
Oct. 19, 2021 (EP) 21203486.2

(51) Int. Cl. C08L 69/00; C08J 3/00

(52) U.S. Cl. CPC C08L 69/005; C08J 3/005

(57) ABSTRACT

A thermoplastic composition includes particular amounts of a first polycarbonate having repeating units derived from a cyclohexylidene-bridged bisphenol and a second polycarbonate that is different from the first polycarbonate and is a recycled polycarbonate. Methods of making the composition are also disclosed. The thermoplastic composition can be particularly useful in a variety of articles.

### CROSS REFERENCE TO RELATED APPLICATION

This application claims priority to and the benefit of European Patent Application No. 21203486.2, filed on Oct. 19, 2021, the contents of which are incorporated by reference herein in their entirety.

### BACKGROUND

This disclosure relates to thermoplastic compositions, a method of forming the same, and articles derived therefrom.

Polycarbonate (PC) has excellent impact strength and transparency but tends to lack scratch-resistant properties. Efforts to improve scratch resistance include, for example, hard-coating the compositions or inclusion of anti-scratch additives into the compositions. These approaches may not be desirable in all applications. For example, in the case of hard-coating, an expensive additional processing step is introduced to the manufacturing process. Addition of impact modifiers has been explored to improve impact strength; however, impact modifiers can negatively affect scratch visibility (e.g., by making scratches appear whiter).

Accordingly, there remains a continuing need in the art for scratch-resistant compositions also having good mechanical properties including impact strength and tensile properties, good thermal properties, and high melt flow. Particularly desired are compositions that do not require a hard-coating or scratch resistant additives. It would be a further advantage to provide a sustainable thermoplastic composition including a recycled component.

### SUMMARY

A thermoplastic composition comprises greater than 50 to 95 weight percent of a first polycarbonate comprising repeating units derived from a cyclohexylidene-bridged bisphenol; 5 to less than 50 weight percent of a second polycarbonate that is different from the first polycarbonate, wherein the second polycarbonate is a recycled polycarbonate; and less than 3 weight percent of a reinforcing filler; wherein weight percent of each component is based on the total weight of the thermoplastic composition.

A method of making the composition comprises melt-mixing the components of the composition.

An article comprises the composition, preferably wherein the article is a housing for a consumer electronic component.

The above described and other features are exemplified by the following FIGURE and detailed description.

### BRIEF DESCRIPTION OF THE DRAWINGS

The following FIGURE represents an exemplary embodiment.

FIG. 1 is a graph showing 10N scratch width (micrometers, μm) for various examples.

### DETAILED DESCRIPTION

Provided herein is a composition having a combination of good scratch resistance, impact resistance and thermal resistance. The compositions include particular amounts of a polycarbonate comprising repeating units derived from a cyclohexylidene-bridged bisphenol and a recycled polycarbonate.

Accordingly, a composition represents an aspect of the present disclosure. The composition comprises a first polycarbonate comprising repeating units derived from a cyclohexylidene-bridged bisphenol. The repeating units derived from the cyclohexylidene-bridged bisphenol can be according to formula (1)

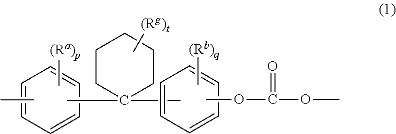

wherein R^{a} and R^{b} are each independently C₁₋₁₂ alkyl; R^{g} is C₁₋₁₂ alkyl; p and q are each independently 0 to 4; and t is 0 to 10. In an aspect, at least one of each of R^{a} and R^{b} are disposed meta to the cyclohexylidene bridging group. In an aspect, R^{a} and R^{b} are each independently C₁₋₄ alkyl, R^{g} is C₁₋₄ alkyl, p and q are each 0 or 1, and t is 0 to 5. In an aspect, R^{a}, R^{b}, and R^{g} are each methyl, p and q are each 0 or 1, and t is 0 or 3, preferably 0. In still another aspect, p and q are each 0, each R^{g} is methyl, and t is 3, such that the cyclohexylidene bridging group is 3,3-dimethyl-5-methyl cyclohexylidene. In another aspect, p and q are each 1, R^{a} and R^{b} are each methyl groups, and t is 0, such that the cyclohexylidene bridging group is an unsubstituted cyclohexylidene. For example, the first polycarbonate can comprise repeating units according to formula (2)

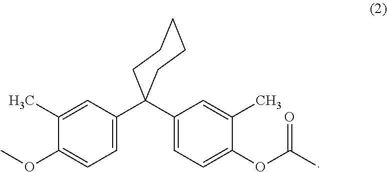

“Polycarbonates” as used herein includes homopolymers (e.g., wherein all repeating units are according to formula (2)), copolymers comprising repeating units derived from different bisphenols, and copolymers comprising carbonate units according to formula (2) and other types of polymer units, such as ester units or siloxane units.

In an aspect, the first polycarbonate can be a copolycarbonate further comprising repeating units derived from a bisphenol different from the cyclohexylidene-bridged bisphenol. For example, the copolycarbonate can comprise additional repeating units according to formula (3)

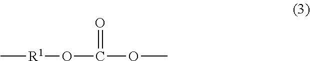

wherein each R¹ contains at least one C₆₋₃₀ aromatic group. For example, each R¹ can be derived from a dihydroxy compound such as an aromatic dihydroxy compound of formula (4) or a bisphenol of formula (5).

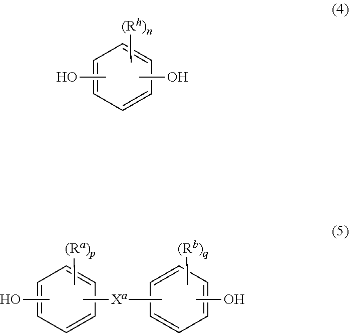

In formula (4), each R^{h} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4. In formula (5), R^{a} and R^{b} are each independently a halogen, C₁₋₁₂ alkoxy, or C₁₋₁₂ alkyl, and p and q are each independently integers of 0 to 4, such that when p or q is less than 4, the valence of each carbon of the ring is filled by hydrogen. In an aspect, p and q is each 0, or p and q is each 1, and R^{a} and R^{b} are each a C₁₋₃ alkyl group, preferably methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (preferably para) to each other on the C₆ arylene group, for example, a single bond, —O—, —S—, —S(O)—, —S(O)₂—, —C(O)—, or a C₁₋₁₈ organic group, which can be cyclic or acyclic, aromatic or non-aromatic, and can further comprise heteroatoms such as halogens, oxygen, nitrogen, sulfur, silicon, or phosphorous. For example, X^{a} can be a substituted or unsubstituted C₃₋₁₈ cycloalkylidene; a C₁₋₂₅ alkylidene of the formula —C(R^{c})(R^{d})—wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R¹)— wherein R^{e} is a divalent C₁₋₁₂ hydrocarbon group.

Examples of bisphenol compounds include 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorene, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole; resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like.

Specific dihydroxy compounds include resorcinol, 2,2-bis(4-hydroxyphenyl) propane (“bisphenol A” or “BPA”), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP”, or 3,3-bis(4-hydroxyphenyl)-2-phenylisoindolin-1-one), and 1,1-bis(4-hydroxyphenyl)-3,3,5-trimethylcyclohexane (isophorone bisphenol).

In an aspect, the first polycarbonate is a copolycarbonate further comprising repeating units derived from bisphenol A. For example, the first polycarbonate can comprise repeating units of formula (1) and (3a)

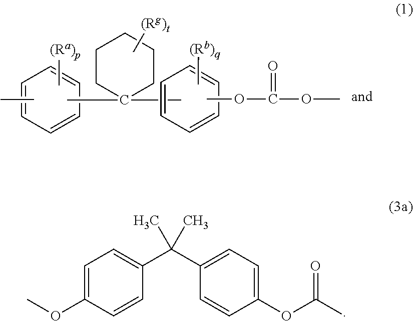

The cyclohexylidene-containing repeating units of formula (1) can be present in an amount of 10 to 50 wt. %, based on the total weight of the first polycarbonate.

In an aspect, the first polycarbonate can comprise repeating units of the formula (1a) and (3a)

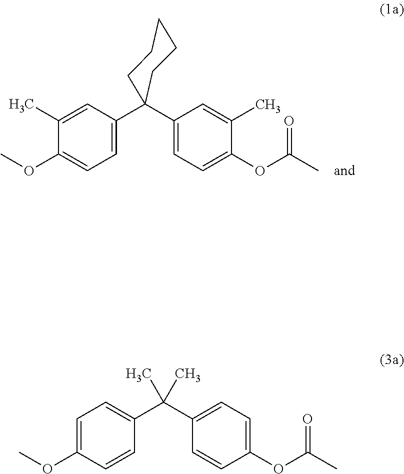

wherein the dimethyl bisphenol cyclohexane carbonate repeating units of formula (1a) can be present in an amount of 10 to 50 wt. %, based on the total weight of the first polycarbonate.

The first polycarbonate can be present in the composition in an amount of greater than 50 to 95 weight percent, based on the total weight of the composition. Within this range, the first polycarbonate can be present in an amount of at least 52 weight percent, or at least 55 weight percent, or at least 60 weight percent, or at least 65 weight percent, or at least 70 weight percent, or at least 75 weight percent. Also within this range, the first polycarbonate can be present in an amount of at most 90 weight percent, or at most 85 weight percent, or at most 80 weight percent, or at most 75 weight percent. In an aspect, the first polycarbonate can be present in an amount of 70 to 80 weight percent, or 72 to 78 weight percent. In an aspect, the first polycarbonate can be present in an amount of 65 to 75 weight percent, or 67 to 72 weight percent.

In addition to the first polycarbonate, the thermoplastic composition further comprises a second polycarbonate. The second polycarbonate is different from the first polycarbonate. The second polycarbonate is a recycled polycarbonate. As used herein, the term “recycled polycarbonate” refers to a polycarbonate that is a post-industrial recycled polycarbonate, a post-consumer recycled polycarbonate, or a combination thereof. In an aspect, the recycled polycarbonate is a post-consumer recycled polycarbonate. The recycled polycarbonate generally comprises at least one impurity or residue that is not present in a corresponding, substantially similar or identical virgin polycarbonate.

The recycled polycarbonate (which can also be referred to as a recycled polycarbonate composition) comprises a polycarbonate. The polycarbonate of the recycled polycarbonate can comprise repeating units according to formula (3) as described previously. In an aspect, the recycled polycarbonate comprises repeating units derived from bisphenol A. In an aspect, the recycled polycarbonate comprises a linear bisphenol A polycarbonate homopolymer.

The recycled polycarbonate can further comprise one or more residual additives. The one or more residual additives can be present, for example, in an amount of 0.0001 to 40 weight percent, based on the total weight of the recycled polycarbonate. Within this range, the one or more residual additives can be present in an amount of 0.001 to 40 weight percent, or 0.01 to 40 weight percent, or 0.1 to 40 weight percent, or 0.1 to 30 weight percent, or 0.1 to 20 weight percent, or 0.1 to 10 weight percent, or 0.1 to 5 weight percent, or 0.1 to 1 weight percent. The one or more residual additives can include, but are not limited to, residual heat stabilizers, residual mold release agents, or derivatives or residues thereof.

The recycled polycarbonate can further optionally include one or more secondary polymers. A secondary polymer can be compatible or incompatible with the primary polycarbonate component of the recycled polycarbonate. An exemplary secondary polymer can include a polyester (e.g., polyethylene terephthalate, polybutylene terephthalate), a polyamide (e.g., Nylon), a polyolefin (e.g., LDPE, LLDPE), a polymeric impact modifier (e.g., high impact polystyrene (HIPS), a styrene acrylonitrile copolymer, a copolymer blend of styrene acrylonitrile and acrylate polymers, acrylonitrile butadiene styrene terpolymer), or a combination comprising at least one of the foregoing. When present, secondary polymers can be present in the recycled polycarbonate in an amount of 0.0001 to 40 weight percent, based on the total weight of the recycled polycarbonate. Within this range, the one or more residual additives can be present in an amount of 0.001 to 40 weight percent, or 0.01 to 40 weight percent, or 0.1 to 40 weight percent, or 0.1 to 30 weight percent, or 0.1 to 20 weight percent, or 0.1 to 10 weight percent, or 0.1 to 5 weight percent, or 0.1 to 1 weight percent, or 0.05 to 1 weight percent, or 0.1 to 0.25 weight percent.

The recycled polycarbonate can be recovered from a waste stream derived from one or more post-consumer sources including, but not limited to, office automation equipment, white goods, consumer electronics, automotive shredder residue, packaging waste, household waste and building waste and post-industrial molding and extrusion scrap. In an aspect, the recycled polycarbonate has not been subjected to any additional purification processes. For example, the recycled polycarbonate of the present disclosure has not been subjected to a purification method, including for example contacting the recycled polycarbonate with any solvent, composition, or combination thereof to provide the recycled polycarbonate in a purified form. For example, in an aspect, the recycled polycarbonate has not been purified by contact with an activated carbon.

The recycled polycarbonate can be present in the composition in an amount of 5 to less than 50 weight percent, based on the total weight of the composition. Within this range, the recycled polycarbonate can be present in an amount of at most 48 weight percent, or at most 45 weight percent, or at most 40 weight percent, or at more 35 weight percent, or at most 30 weight percent, or at most 25 weight percent. Also within this range, the recycled polycarbonate can be present in an amount of at least 10 weight percent, or at least 15 weight percent, or at least 20 weight percent, or at least 25 weight percent. In an aspect, the recycled polycarbonate can be present in an amount of 20 to 30 weight percent, or 22 to 27 weight percent. In an aspect, the recycled polycarbonate can be present in an amount of 25 to 35 weight percent, or 28 to 33 weight percent.

In addition to the first polycarbonate and the second polycarbonate, the thermoplastic composition can optionally further comprise an additive composition. The additive composition can comprise one or more additive selected to achieve a desired property, with the proviso that the additive(s) are also selected so as to not significantly adversely affect a desired property of the thermoplastic composition. The additive composition or individual additives can be mixed at a suitable time during the mixing of the components for forming the composition. The additive can be soluble or non-soluble in polycarbonate. The additive composition can include an impact modifier, flow modifier, filler (e.g., a particulate polytetrafluoroethylene (PTFE), glass, carbon, mineral, or metal), reinforcing agent (e.g., glass fibers), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, flame retardant, anti-drip agent (e.g., a PTFE-encapsulated styrene-acrylonitrile copolymer (TSAN)), or a combination thereof. For example, a combination of a heat stabilizer, mold release agent, and ultraviolet light stabilizer can be used. The additives can be used in amounts generally known to be effective. For example, the total amount of the additive composition (other than any impact modifier, filler, or reinforcing agent) can be 0.001 to 10 weight percent, or 0.01 to 5 weight percent, or 0.1 to 10 weight percent, each based on the total weight of the composition.

In an aspect, the composition can include a heat stabilizer additive. Heat stabilizer additives include organophosphites (e.g., triphenyl phosphite, tris-(2,6-dimethylphenyl)phosphite, tris-(mixed mono- and di-nonylphenyl)phosphite or the like), phosphonates (e.g., dimethylbenzene phosphonate or the like), phosphates (e.g., trimethyl phosphate, or the like), or a combination thereof. The heat stabilizer can be tris(2,4-di-t-butylphenyl) phosphate available as IRGAPHOS™ 168. Heat stabilizers are generally used in amounts of 0.01 to 5 wt %, based on the total weight of the composition.

There is considerable overlap among plasticizers, lubricants, and mold release agents, which include, for example, phthalic acid esters (e.g., octyl-4,5-epoxy-hexahydrophthalate), tris-(octoxycarbonylethyl)isocyanurate, di- or polyfunctional aromatic phosphates (e.g., resorcinol tetraphenyl diphosphate (RDP), the bis(diphenyl) phosphate of hydroquinone and the bis(diphenyl) phosphate of bisphenol A); poly-alpha-olefins; epoxidized soybean oil; silicones, including silicone oils (e.g., poly(dimethyl diphenyl siloxanes); fatty acid esters (e.g., C₁₋₃₂ alkyl stearyl esters, such as methyl stearate and stearyl stearate and esters of stearic acid such as pentaerythritol tetrastearate, glycerol tristearate (GTS), and the like), waxes (e.g., beeswax, montan wax, paraffin wax, or the like), or a combination thereof. These are generally used in amounts of 0.01 to 5 wt %, based on the total weight of the composition.

Light stabilizers, in particular ultraviolet light (UV) absorbing additives, also referred to as UV stabilizers, include hydroxybenzophenones (e.g., 2-hydroxy-4-n-octoxy benzophenone), hydroxybenzotriazines, cyanoacrylates, oxanilides, benzoxazinones (e.g., 2,2′-(1,4-phenylene)bis(4H-3,1-benzoxazin-4-one, commercially available under the trade name CYASORB UV-3638 from Cytec), aryl salicylates, hydroxybenzotriazoles (e.g., 2-(2-hydroxy-5-methylphenyl)benzotriazole, 2-(2-hydroxy-5-tert-octylphenyl)benzotriazole, and 2-(2H-benzotriazol-2-yl)-4-(1,1,3,3-tetramethylbutyl)-phenol, commercially available under the trade name CYASORB 5411 from Cytec) or a combination thereof. The UV stabilizers can be present in an amount of 0.01 to 1 wt %, preferably, 0.1 to 0.5 wt %, and more preferably, 0.15 to 0.4 wt %, based on the total weight of the composition.

Possible fillers or reinforcing agents include, for example, mica, clay, feldspar, quartz, quartzite, perlite, tripoli, diatomaceous earth, aluminum silicate (mullite), synthetic calcium silicate, fused silica, fumed silica, sand, boron-nitride powder, boron-silicate powder, calcium sulfate, calcium carbonates (such as chalk, limestone, marble, and synthetic precipitated calcium carbonates) talc (including fibrous, modular, needle shaped, and lamellar talc), wollastonite, hollow or solid glass spheres, silicate spheres, cenospheres, aluminosilicate or (armospheres), kaolin, whiskers of silicon carbide, alumina, boron carbide, iron, nickel, or copper, continuous and chopped carbon fibers or glass fibers, molybdenum sulfide, zinc sulfide, barium titanate, barium ferrite, barium sulfate, heavy spar, TiO₂, aluminum oxide, magnesium oxide, particulate or fibrous aluminum, bronze, zinc, copper, or nickel, glass flakes, flaked silicon carbide, flaked aluminum diboride, flaked aluminum, steel flakes, natural fillers such as wood flour, fibrous cellulose, cotton, sisal, jute, starch, lignin, ground nut shells, or rice grain husks, reinforcing organic fibrous fillers such as poly(ether ketone), polyimide, polybenzoxazole, poly(phenylene sulfide), polyesters, polyethylene, aromatic polyamides, aromatic polyimides, polyetherimides, polytetrafluoroethylene, and poly(vinyl alcohol), as well a combination thereof. The fillers and reinforcing agents can be coated with a layer of metallic material to facilitate conductivity, or surface treated with silanes to improve adhesion and dispersion with the polymer matrix. Fillers are used in amounts of 1 to 200 parts by weight, based on 100 parts by weight of the total composition.

Colorants such as pigment or dye additives can also be present. Useful pigments can include, for example, inorganic pigments such as metal oxides and mixed metal oxides such as zinc oxide, titanium dioxides, iron oxides, or the like; sulfides such as zinc sulfides, or the like; aluminates; sodium sulfo-silicates sulfates, chromates, or the like; carbon blacks; zinc ferrites; ultramarine blue; organic pigments such as azos, di-azos, quinacridones, perylenes, naphthalene tetracarboxylic acids, flavanthrones, isoindolinones, tetrachloroisoindolinones, anthraquinones, enthrones, dioxazines, phthalocyanines, and azo lakes; Pigment Red 101, Pigment Red 122, Pigment Red 149, Pigment Red 177, Pigment Red 179, Pigment Red 202, Pigment Violet 29, Pigment Blue 15, Pigment Blue 60, Pigment Green 7, Pigment Yellow 119, Pigment Yellow 147, Pigment Yellow 150, Pigment Brown 24, Pigment Blue 29, or a combination thereof.

Dyes are generally organic materials and include coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; pyrazolone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; or a combination thereof.

A thermoplastic polymer different from the first polycarbonate and the second polycarbonate can also be present. Examples of thermoplastic polymers that can be used include polyacetals (e.g., polyoxyethylene and polyoxymethylene), poly(C₁₋₆ alkyl)acrylates, polyacrylamides, polyamides, (e.g., aliphatic polyamides, polyphthalamides, and polyaramides), polyamideimides, polyanhydrides, polyarylates, polyarylene ethers (e.g., polyphenylene ethers), polyarylene sulfides (e.g., polyphenylene sulfides), polyarylene sulfones (e.g., polyphenylene sulfones), polybenzothiazoles, polybenzoxazoles, polycarbonates (including polycarbonate copolymers such as polycarbonate-siloxanes, polycarbonate-esters, and polycarbonate-ester-siloxanes), polyesters (e.g., polyethylene terephthalates, polybutylene terephthalates, polyarylates, and polyester copolymers such as polyester-ethers), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), poly(C₁₋₆ alkyl)methacrylates, polymethacrylamides, polynorbornenes (including copolymers containing norbornenyl units), polyolefins (e.g., polyethylenes, polypropylenes, polytetrafluoroethylenes, and their copolymers, for example ethylene-alpha-olefin copolymers), polyoxadiazoles, polyoxymethylenes, polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl ketones, polyvinyl thioethers, polyvinylidene fluorides, or the like, or a combination thereof.

In an aspect, the thermoplastic composition can further comprise a polycarbonate different from the first and the second polycarbonate. In an aspect, the thermoplastic composition can further comprise a virgin (i.e., not derived from recycled material) polycarbonate that is different from the first and the second polycarbonate. The virgin polycarbonate can be identical to the second (recycled) polycarbonate, except that it has not been recycled. An identical virgin polycarbonate can, for example, be free of one or more impurities or residues present in a recycled polycarbonate. In an aspect, the additional thermoplastic polymer can be a virgin polycarbonate comprising repeating units derived from bisphenol A. In an aspect, the additional polycarbonate can be the same as the second polycarbonate except that it is a virgin polycarbonate, whereas the second polycarbonate is a recycled polycarbonate, as described above.

When present, the additional thermoplastic polymer can be present in an amount of 1 to 15 weight percent, based on the total weight of the thermoplastic composition. For example, the additional thermoplastic polymer can be present in an amount of 2 to 12 weight percent, or 4 to 11 weight percent, or 5 to 10 weight percent.

In an aspect, the thermoplastic composition can comprise 72 to 78 weight percent of the first polycarbonate; 18 to 25 weight percent of the second polycarbonate; and 3 to 10 weight percent of an additive composition. In an aspect, the thermoplastic composition can comprise 67 to 72 weight percent of the first polycarbonate; 22 to 30 weight percent of the second polycarbonate; and 3 to 10 weight percent of an additive composition.

In an aspect, the thermoplastic composition can include 67 to 90 weight percent of the first polycarbonate; 8 to 30 weight percent of the second polycarbonate; and 2 to 10 weight percent of an additive composition. The first polycarbonate can comprise repeating units of formula

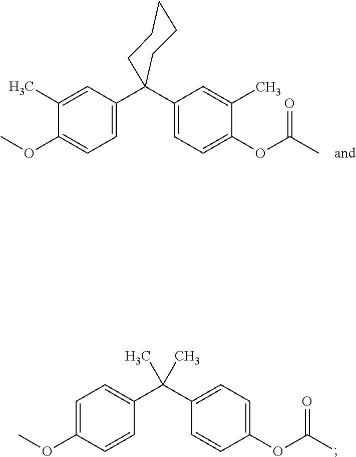

wherein the dimethyl bisphenol cyclohexane carbonate repeating units are present in an amount of 10 to 50 wt. %, based on the total weight of the first polycarbonate; and the recycled polycarbonate can comprise a linear bisphenol A polycarbonate.

In an aspect, the thermoplastic composition can include 45 to 85 weight percent of the first polycarbonate; 5 to 40 weight percent of the second polycarbonate; 1 to 15 weight percent of a virgin polycarbonate, and 1 to 10 weight percent of an additive composition. The first polycarbonate can comprise repeating units of formula

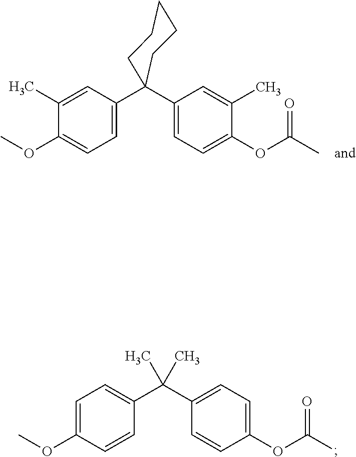

wherein the dimethyl bisphenol cyclohexane carbonate repeating units are present in an amount of 10 to 50 wt. %, based on the total weight of the first polycarbonate. The recycled polycarbonate can comprise a linear bisphenol A polycarbonate. The virgin polycarbonate can comprise a virgin linear bisphenol A polycarbonate.

The composition can optionally exclude other components not specifically described here. For example, the composition can minimize or exclude thermoplastic polymers other than the first polycarbonate, the second polycarbonate, and optionally the virgin polycarbonate (e.g., wherein any additional thermoplastic polymer is present in an amount of no more than 5 weight percent, or no more than 1 weight percent, or no more than 0.5 weight percent, or no more than 0.1 weight percent). In an aspect, the composition can minimize or exclude reinforcing fillers. For example, the composition can comprise less than 3 weight percent, or less than 1 weight percent, or less than 0.5 weight percent of reinforcing fillers, each based on the total weight of the composition. In an aspect, the composition can exclude reinforcing fillers. In an aspect, the composition can minimize or exclude flame retardants, for example phosphazene flame retardants (e.g., the composition can comprise less than 3 weight percent, or less than 1 weight percent, or less than 0.5 weight percent of a flame retardant, each based on the total weight of the composition.

The composition provided herein can exhibit good scratch resistance, impact strength and thermal resistance when a particular combination of the first and second polycarbonates are present in the composition, each in particular amounts. A molded sample of the composition can exhibit one or more of improved scratch resistance, impact strength and thermal resistance. Without wishing to be bound by theory, it is believed that the unexpected combination of scratch resistance, impact strength, and thermal resistance is achieved by the careful selection of the components of the composition.

In an aspect, a molded sample of the composition can exhibit good impact strength. For example, a molded sample of the composition can exhibit a notched Izod impact strength of greater than 25 J/m, preferably 27 J/m to 50 J/m, or 30 J/m to 45 J/m as measured in accordance with ASTM D256-10 under a load of 5 lbf at a temperature of 23° C. For example, a molded sample of the composition can exhibit a notched Izod impact strength of greater than 25 J/m, preferably 27 J/m to 50 J/m, or 30 J/m to 45 J/m as measured in accordance with ASTM D256-10 under a load of 5 lbf at a temperature of −30° C.

A molded sample of the composition can exhibit a heat deflection temperature (HDT) of at least 90° C., or 90 to 125° C., as determined according to ISO 75 on a sample plaque of 4.00 mm thickness at 0 1.8 MPa.

A molded sample of the composition can also exhibit good scratch resistance. For example, a molded sample of the composition can exhibit a 10N scratch width that is within 5% of the scratch width of a composition not including the recycled polycarbonate, or wherein a molded sample of the composition exhibits a reduction in 10N scratch width of at least 3%, or at least 5%. Scratch resistance can be determined according to the procedure further described in the working examples.

The thermoplastic composition of the present disclosure can be manufactured according to various methods. For example, the first polycarbonate, the second polycarbonate and other optional components can be first blended, optionally with any fillers, in a high-speed mixer or by hand-mixing. The blend is then fed into the throat of a twin-screw extruder via a hopper. Alternatively, at least one of the components can be incorporated into the composition by feeding it directly into the extruder at the through and/or downstream through a side stuffer, or by being compounded into a masterbatch with a desired polymer and fed into the extruder. The extruder is generally operated at a temperature higher than that necessary to cause the composition to flow. The extrudate can be immediately quenched in a water bath and pelletized. The pellets so prepared can be one-fourth inch long or less as desired. Such pellets can be used for subsequent molding, shaping, or forming.

Shaped, formed, casted, or molded articles comprising the composition are also provided. The composition can be molded into shaped articles by a variety of methods, such as injection molding, extrusion, rotational molding, blow molding, and thermoforming. The article can be a molded article, a thermoformed article, an extruded film, an extruded sheet, a honeycomb structure, one or more layers of a multi-layer article, a substrate for a coated article, or a substrate for a metallized article.

Articles comprising the composition can be used in various consumer products. In an aspect, the article can be an automotive component. In an aspect, the article can be a consumer electronic component, for example a housing for a consumer electronic device.

Articles can include, but are not limited to, exterior automobile components (e.g., grill, mirror housing, pillar, spoiler, logo, roof rail, bezel, trim, fender), interior automobile components (e.g., decorative parts, electronic housings, instrument panel components, navigation system, housing frames), storage boxes, a personal equipment part, a home appliance component, furniture, appliance housings (e.g., robot cleaners, drones), and consumer electronics devices (e.g., device housings or components for laptops, phones, tablets, batteries, wireless charging, AR/VR goggles).

In an aspect the article can be an automotive bumper, an automotive exterior component, an automobile mirror housing, an automobile wheel cover, an automobile instrument panel or trim, an automobile glove box, an automobile door hardware or other interior trim, an automobile exterior light, an automobile part within the engine compartment, an agricultural tractor or device part, a window or a component thereof, a construction equipment vehicle or device part, a marine or personal water craft part, an all-terrain vehicle or all-terrain vehicle part, plumbing equipment, a valve or pump, an air conditioning heating or cooling part, a furnace or heat pump part, a computer housing, a computer housing or business machine housing or part, a housing or part for monitors, a computer router, a desk top printer, a large office/industrial printer, an electronics part, a projector part, an electronic display part, a copier part, a scanner part, an electronic printer toner cartridge, a handheld electronic device housing, a housing for a hand-held device, a hair drier, an iron, a coffee maker, a toaster, a washing machine or washing machine part, a microwave, an oven, a power tool, an electric component, an electric enclosure, a lighting part, a component for a lighting fixture, a dental instrument, a medical instrument, a medical or dental lighting part, an aircraft part, a train or rail part, a seating component, a sidewall, a ceiling part, cookware, a medical instrument tray, an animal cage, fibers, a laser welded medical device, fiber optics, a lens (auto and non-auto), a cell phone part, a greenhouse component, a sun room component, a fire helmet, a safety shield, safety glasses, a gas pump part, a humidifier housing, a thermostat control housing, an air conditioner drain pan, an outdoor cabinet, a telecom enclosure or infrastructure, a Simple Network Detection System (SNIDS) device, a network interface device, a smoke detector, a component or device in a plenum space, a medical scanner, X-ray equipment, a component for a medical application or a device, an electrical box or enclosure, and an electrical connector, a construction or agricultural equipment, and a turbine blade.

In an aspect the article can be a component of an aircraft interior or a train interior, an access panel, access door, air flow regulator, air gasper, air grille, arm rest, baggage storage door, balcony component, cabinet wall, ceiling panel, door pull, door handle, duct housing, enclosure for an electronic device, equipment housing, equipment panel, floor panel, food cart, food tray, galley surface, handle, housing for television, light panel, magazine rack, telephone housing, partition, part for trolley cart, seat back, seat component, railing component, seat housing, shelve, side wall, speaker housing, storage compartment, storage housing, toilet seat, tray table, tray, trim panel, window molding, window slide, a balcony component, baluster, ceiling panel, cover for a life vest, cover for a storage bin, dust cover for a window, layer of an electrochromic device, lens for a television, electronic display, gauge, or instrument panel, light cover, light diffuser, light tube, light pipes, mirror, partition, railing, refrigerator door, shower door, sink bowl, trolley cart container, trolley cart side panel, or window.

This disclosure is further illustrated by the following examples, which are non-limiting.

### Examples

Materials used in the following examples are described in Table 1.

TABLE 1

| Component | Description | Supplier |
|---|---|---|
| PC-1 | Polycarbonate comprising repeating units derived from bisphenol A | SABIC |
| | (BPA) and dimethyl bisphenol cyclohexane (DMBPC), having a Mw | |
| | of 22,000 to 35,000 grams per mole as determined by gel permeation | |
| | chromatography relative to linear bisphenol A polycarbonate standards | |
| PC-2 | Linear bisphenol A polycarbonate having a Mw of 20,000-22,000 | SABIC |
| | grams per mole, as determined by gel permeation chromatography | |
| | relative to linear bisphenol A polycarbonate standards, produced | |
| | by interfacial polymerization and endcapped with p-cumylphenol | |
| PC-3 | Post-consumer recycled (PCR) polycarbonate from recycled | Ningbo Xuri |
| | polycarbonate parts which may contain typical additives | Hongyu |
| | such as heat stabilizers, UV absorbers, mold release agents, | Technology |
| | or residues thereof in an amount of at least 1 ppm. | Co., Ltd |
| BZT | 2-(2H-benzotriazol-2-yl)-4-(1,1,3,3-tetramethylbutyl)-phenol, | Cytec |
| | obtained as CYASORB 5411 | |
| PETS | Pentaerythritol tetrastearate, CAS Reg. No. 115-83-3 | FACI SpA |
| TBPP | Tris(2,4-di-tert-butylphenyl) phosphite, CAS Reg. No. | BASF |
| | 31570-04-4; obtained as IRGAFOS ™ 168 | |
| TiO₂ | Coated Titanium dioxide | KRONOS |
| Brightener | 2,2′-(1,2-ethenediyldi-4,1-phenylene)bisbenzoxazole; | Eastman |
| | CAS 1533-45-5 | Chemical Co |
| Pigment | Pigment Blue 29, CAS Reg. No. 57455-37-5 | Nubiola, Inc |
| Blue 29 | | |
| Solvent | Solvent Yellow 93, CAS Reg. No. 4702-90-3, | Lanxess |
| Yellow 93 | obtained as MACROLEX Yellow 3G | |

The compositions of the following examples were prepared by blending the components together and extruding on a 37 mm twin-screw extruder at a temperature of 285 to 330° C., though it will be recognized by one skilled in the art that the method is not limited to these temperatures. The compositions were subsequently injection molded at a temperature of 285 to 380° C., though it will be recognized by one skilled in the art that the method is not limited to these temperatures.

Physical measurements were made using the tests and test methods described below.

Melt volume-flow rate (MVR) was determined in accordance with ASTM D1238 under a load of 1.2 kg at 300° C. with a dwell time of 360 s or 1080 s. Prior to the testing the pellets were pre-dried at 120° C. for 3 hours

High shear viscosity was determined in accordance with ISO 11443 at a temperature of 300° C.

Notched Izod impact Strength (INI) was determined in accordance with ASTM D256-10 under a load of 5 lbf at different temperatures including a temperature of 23° C. or −30° C. All ASTM INI determinations were carried out on sample plaques of 3.2 mm thickness. For the test at −30° C., the test specimens were placed in the freezer for more than 4 hours then taken out for testing at room temperature within five seconds.

Heat deflection temperature (HDT), expressed in units of ° C., was determined according to ASTM D648 at 1.82 MPa or 0.45 MPa using a bar having a thickness of 3.2 millimeters.

Tensile properties were measured in accordance with ASTM D638 at 50 mm/min at room temperature on standard ASTM tensile bars having a thickness of 3.2 millimeters.

Color (L*) was calculated from the absorption spectrum of a 2.5 mm color plaque between 350 nm and 780 nm. The spectrum was measured on an X-Rite benchtop spectrophotometer Ci7800 using wide-band fluorescent lamps (CWF—cool white fluorescent) in reflective mode and UV excluded.

Scratch resistance was evaluated using the 5-finger scratch test by Taber Industries, which is similar to the standard surface hardness scratch test method described in ASTM D7027-20 and ISO19252. A stylus pin is held at a 90 degree angle to the surface of a color plaque of 2.5 mm thickness and under a constant load of 3, 5, 7, 10 or 15 Newtons downward force, then the plaques are dragged under the stylus pins. The width (in micrometers) of the resulting scratches produced on the surface under 10N load was measured with a microscope.

Compositions and test results are shown in Table 2. In Table 2, the amount of each component is provided in weight percent, based on the total weight of the composition.

TABLE 2

| Component | Units | CE1 | E1 | E2 | E3 | E4 | E5 | E6 | E7 | E8 |
|---|---|---|---|---|---|---|---|---|---|---|
| PC-1 | wt % | 80 | 84.5815 | 79.5815 | 74.5815 | 69.5815 | 44.5815 | 79.5815 | 74.5815 | 49.5815 |
| PC-2 | wt % | 14.5815 | | | | | | 5 | 5 | 10 |
| PC-3 | wt % | | 10 | 15 | 20 | 25 | 50 | 10 | 15 | 35 |
| BZT | wt % | 0.3 | 0.3 | 0.3 | 0.3 | 0.3 | 0.3 | 0.3 | 0.3 | 0.3 |
| PETS | wt % | 0.27 | 0.27 | 0.27 | 0.27 | 0.27 | 0.27 | 0.27 | 0.27 | 0.27 |
| TBPP | wt % | 0.06 | 0.06 | 0.06 | 0.06 | 0.06 | 0.06 | 0.06 | 0.06 | 0.06 |
| TiO₂ | wt % | 4.76 | 4.76 | 4.76 | 4.76 | 4.76 | 4.76 | 4.76 | 4.76 | 4.76 |
| Brightener | wt % | 0.017 | 0.017 | 0.017 | 0.017 | 0.017 | 0.017 | 0.017 | 0.017 | 0.017 |
| Pigment Blue 29 | wt % | 0.0105 | 0.0105 | 0.0105 | 0.0105 | 0.0105 | 0.0105 | 0.0105 | 0.0105 | 0.0105 |
| Solvent Yellow 93 | wt % | 0.001 | 0.001 | 0.001 | 0.001 | 0.001 | 0.001 | 0.001 | 0.001 | 0.001 |
| Properties | | | | | | | | | | |
| MVR (360 s) | cm³/10 | 17.6 | 16.1 | 16.3 | 16.2 | 17.0 | 17.9 | 16.7 | 16.8 | 18.5 |
| | min | | | | | | | | | |
| MVR (1080 s) | cm³/10 | 19.0 | 17.9 | 18.1 | 18 | 18.5 | 19.6 | 18.5 | 18.6 | 20.0 |
| | min | | | | | | | | | |
| App. Shear Rate | 1/s | 640 | 640 | 640 | 640 | 640 | 640 | 640 | 640 | 640 |
| App. Viscosity | Pa-s | 268.7 | 271.8 | 268.1 | 271.1 | 257.3 | 264.0 | 257.6 | 264.3 | 249.2 |
| Ductility, 23° C. | % | 0 | 0 | 0 | 0 | 0 | 0 | 0 | 0 | 0 |
| INI, 23° C. | J/m | 32.6 | 32.4 | 33.3 | 35.2 | 32.4 | 49.7 | 32.6 | 31.6 | 48.6 |
| Ductility, −30° C. | % | 0 | 0 | 0 | 0 | 0 | 0 | 0 | 0 | 0 |
| INI, −30° C. | J/m | 32.9 | 31.6 | 31.5 | 32 | 32.1 | 42.5 | 32 | 32.8 | 32.0 |
| HDT, 0.45 MPa | ° C. | 132.4 | 131.9 | 132.1 | 131.8 | 132.6 | 133.5 | 131.3 | 131.9 | 132.6 |
| HDT, 1.82 MPa | ° C. | 117.3 | 118.6 | 118.8 | 119.3 | 118.7 | 119.5 | 118.1 | 119.9 | 120.2 |
| Tens. Mod. | MPa | 2496 | 2514 | 2510 | 2502 | 2478 | 2432 | 2502 | 2482 | 2440 |
| Tens. Strength, | MPa | 73.5 | 74.3 | 73.6 | 73.6 | 73.1 | 70.3 | 73.8 | 73 | 70.9 |
| yield | | | | | | | | | | |
| Tens. Strength, | MPa | 61.1 | 59.3 | 58.1 | 58.7 | 58.6 | 59.6 | 58.7 | 58.1 | 56.8 |
| break | | | | | | | | | | |
| Tens. Elong., yield | % | 7.6 | 7.65 | 7.61 | 7.52 | 7.5 | 7.1 | 7.64 | 7.46 | 7.2 |
| Tens. Elong., break | % | 50.3 | 60.83 | 49.97 | 74.99 | 75.3 | 100.4 | 68.13 | 52.76 | 94.0 |
| Color, L* | | 97.6 | 97.6 | 97.4 | 97.4 | 97.1 | 96.5 | 97.6 | 97.5 | 97.0 |

As shown in Table 2, comparative example 1 shows a composition including DMBPC-containing polycarbonate (PC-1) and bisphenol A polycarbonate (PC-2). Replacing PC-2 with a recycled polycarbonate (PC-3) provided compositions exhibiting physical properties similar to those of comparative example 1, with increasing amounts of PC-3 observed to increase the tensile elongation at break by up to 100% (E1-E5). The compositions of examples 6-8 show that similar properties can be obtained using a blend comprising both PC-2 and PC-3. All compositions also exhibited high L* (>96.5).

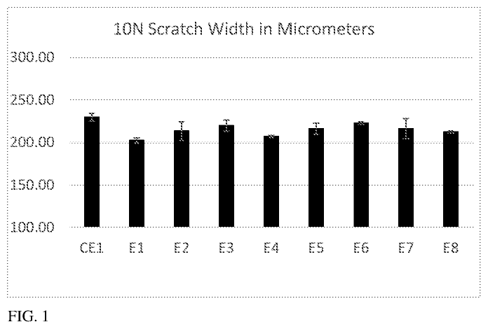

The compositions of CE1 and E1-E8 were further evaluated for scratch resistance. FIG. 1 shows the 10N scratch width measured for each composition. As can be seen from FIG. 1, improved scratch resistance (as indicated by reduced 10N scratch width) was observed for each of the compositions of E1-E8 relative to that of CE1.

Accordingly, compositions having improved scratch resistance can be achieved by including a recycled polycarbonate component. The compositions described herein offer sustainable content, wide color space capability, high melt flow for thin wall capabilities, and improved scratch resistance.

This disclosure further encompasses the following aspects.

Aspect 1: A thermoplastic composition comprising: greater than 50 to 95 weight percent of a first polycarbonate comprising repeating units derived from a cyclohexylidene-bridged bisphenol; 5 to less than 50 weight percent of a second polycarbonate that is different from the first polycarbonate, wherein the second polycarbonate is a recycled polycarbonate; and less than 3 weight percent of a reinforcing filler; wherein weight percent of each component is based on the total weight of the thermoplastic composition.

Aspect 2a: The thermoplastic composition of aspect 1, wherein a molded sample of the composition exhibits a 10N scratch width that is within 5% of the scratch width of a composition not including the recycled polycarbonate.

Aspect 2b: The thermoplastic composition of aspect 1, wherein a molded sample of the composition exhibits a reduction in 10N scratch width of at least 3%, or at least 5%.

Aspect 3: The thermoplastic composition of aspects 1 or 2, wherein the first polycarbonate comprises repeating units of the formula

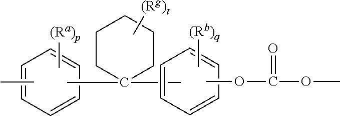

wherein R^{a} and R^{b} are each independently C₁₋₁₂ alkyl, preferably methyl; R^{g} is C₁₋₁₂ alkyl; p and q are each independently 0 to 4, preferably 1; and t is 0 to 10, preferably 0.

Aspect 4: The thermoplastic composition of aspect 3, wherein the first polycarbonate further comprises repeating units derived from bisphenol A.

Aspect 5: The thermoplastic composition of any of aspects 1 to 4, wherein the first polycarbonate comprises repeating units of the formula

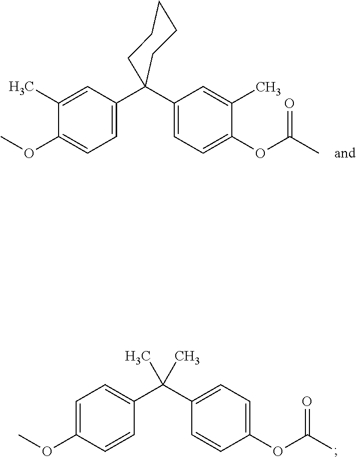

wherein the dimethyl bisphenol cyclohexane carbonate repeating units are present in an amount of 10 to 50 wt. %, based on the total weight of the first polycarbonate.

Aspect 6: The thermoplastic composition of any of aspects 1 to 5, wherein the recycled polycarbonate is a post-industrial recycled polycarbonate, a post-consumer recycled polycarbonate, or a combination thereof, preferably a post-consumer recycled polycarbonate.

Aspect 7: The thermoplastic composition of any of aspects 1 to 6, wherein the recycled polycarbonate comprises a linear bisphenol A polycarbonate.

Aspect 8: The thermoplastic composition of any of aspects 1 to 7, wherein the recycled polycarbonate comprises one or more of: a residual additive; or a residual secondary polymer.

Aspect 9: The thermoplastic composition of any of aspects 1 to 8, further comprising 0.1 to 10 weight percent of an additive composition; or 1 to 15 weight percent of a virgin polycarbonate; or both.

Aspect 10: The thermoplastic composition of any of aspects 1 to 9, comprising 67 to 90 weight percent of the first polycarbonate; 8 to 30 weight percent of the second polycarbonate; and 2 to 10 weight percent of an additive composition; wherein the first polycarbonate comprises repeating units of formula

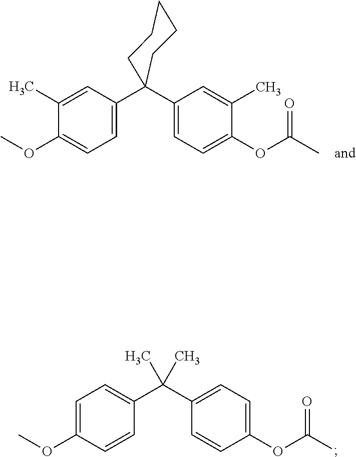

wherein the dimethyl bisphenol cyclohexane carbonate repeating units are present in an amount of 10 to 50 wt. %, based on the total weight of the first polycarbonate; and the recycled polycarbonate comprises a linear bisphenol A polycarbonate.

Aspect 11: The thermoplastic composition of any of aspects 1 to 9, comprising 45 to 85 weight percent of the first polycarbonate; 5 to 40 weight percent of the second polycarbonate; 1 to 15 weight percent of a virgin polycarbonate; and 1 to 10 weight percent of an additive composition; wherein the first polycarbonate comprises repeating units of formula

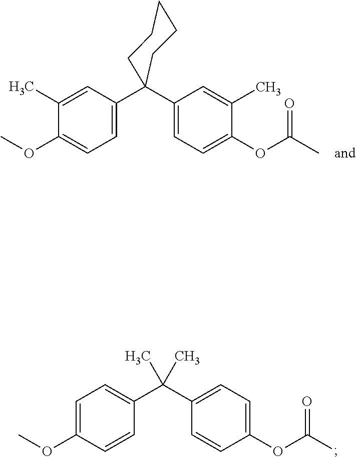

wherein the dimethyl bisphenol cyclohexane carbonate repeating units are present in an amount of 10 to 50 wt. %, based on the total weight of the first polycarbonate; the recycled polycarbonate comprises a linear bisphenol A polycarbonate; and the virgin polycarbonate comprises a linear bisphenol A polycarbonate.

Aspect 12: The thermoplastic composition of aspect 1, comprising 67 to 78 weight percent of the first polycarbonate; 18 to 30 weight percent of the second polycarbonate; and 0.1 to 10 weight percent of an additive composition.

Aspect 13: The thermoplastic composition of aspect 1, comprising 72 to 78 weight percent of the first polycarbonate; 18 to 25 weight percent of the second polycarbonate; and 3 to 10 weight percent of an additive composition.

Aspect 14: The thermoplastic composition of aspect 1, comprising 67 to 72 weight percent of the first polycarbonate; 22 to 30 weight percent of the second polycarbonate; and 3 to 10 weight percent of an additive composition.

Aspect 15: A method of making the composition of any of aspects 1 to 14, the method comprising: melt-mixing the components of the composition.

Aspect 16: An article comprising the composition of any of aspects 1 to 14, preferably wherein the article is a housing for a consumer electronic component.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein and may or may not be present in other aspects. Any aspect can be combined with any other aspect. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A thermoplastic composition comprising:
greater than 50 to 95 weight percent of a first polycarbonate comprising repeating units derived from a cyclohexylidene-bridged bisphenol;
5 to less than 50 weight percent of a second polycarbonate that is different from the first polycarbonate, wherein the second polycarbonate is a recycled polycarbonate; and
less than 3 weight percent of a reinforcing filler;
wherein weight percent of each component is based on the total weight of the thermoplastic composition.

2. The thermoplastic composition of claim 1, wherein a molded sample of the composition exhibits a 10N scratch width that is within 5% of the scratch width of a composition not including the recycled polycarbonate.

3. The thermoplastic composition of claim 1, wherein a molded sample of the composition exhibits a reduction in 10N scratch width of at least 3% compared to a composition not including the recycled polycarbonate.

4. The thermoplastic composition of claim 1, wherein the first polycarbonate comprises repeating units of the formula 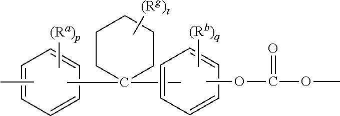
wherein
R^{a} and R^{b} are each independently C₁₋₁₂ alkyl;
R is C₁₋₁₂ alkyl;
p and q are each independently 0 to 4; and
is 0 to 10, preferably 0.

5. The thermoplastic composition of claim 4, wherein the first polycarbonate further comprises repeating units derived from bisphenol A.

6. The thermoplastic composition of a claim 1, wherein the first polycarbonate comprises repeating units of the formula 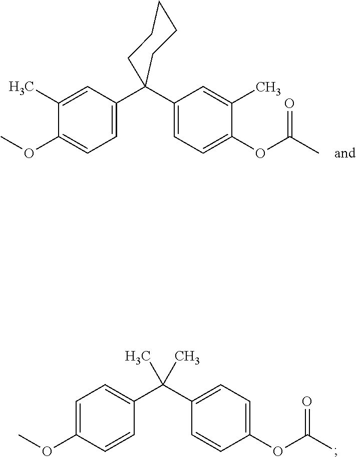
wherein the dimethyl bisphenol cyclohexane carbonate repeating units are present in an amount of 10 to 50 wt. %, based on the total weight of the first polycarbonate.

7. The thermoplastic composition of claim 1, wherein the recycled polycarbonate is a post-industrial recycled polycarbonate, a post-consumer recycled polycarbonate, or a combination thereof.

8. The thermoplastic composition of claim 1, wherein the recycled polycarbonate comprises a linear bisphenol A polycarbonate.

9. The thermoplastic composition of claim 1, wherein the recycled polycarbonate comprises one or more of:
a residual additive; or
a residual secondary polymer.

10. The thermoplastic composition of claim 1, further comprising
0.1 to 10 weight percent of an additive composition; or
1 to 15 weight percent of a virgin polycarbonate;
or both.

11. The thermoplastic composition of claim 1, comprising
67 to 90 weight percent of the first polycarbonate;
8 to 30 weight percent of the second polycarbonate; and
2 to 10 weight percent of an additive composition;
wherein
the first polycarbonate comprises repeating units of formula 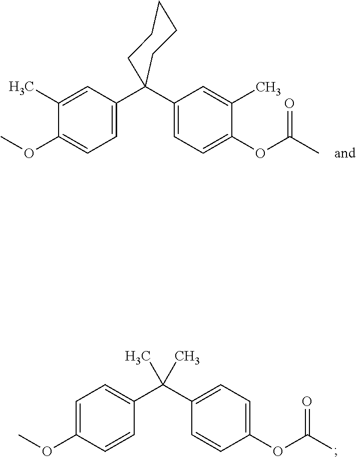
wherein the dimethyl bisphenol cyclohexane carbonate repeating units are present in an amount of 10 to 50 wt. %, based on the total weight of the first polycarbonate; and
the recycled polycarbonate comprises a linear bisphenol A polycarbonate.

12. The thermoplastic composition of claim 1, comprising
45 to 85 weight percent of the first polycarbonate;
5 to 40 weight percent of the second polycarbonate;
1 to 15 weight percent of a virgin polycarbonate; and
1 to 10 weight percent of an additive composition;
wherein
the first polycarbonate comprises repeating units of formula 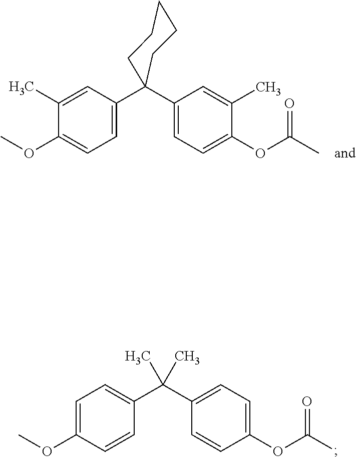
wherein the dimethyl bisphenol cyclohexane carbonate repeating units are present in an amount of 10 to 50 wt,%, based on the total weight of the first polycarbonate;
the recycled polycarbonate comprises a linear bisphenol A polycarbonate; and the
virgin polycarbonate comprises a linear bisphenol A polycarbonate.

13. The thermoplastic composition of claim 1, comprising
67 to 78 weight percent of the first polycarbonate;
18 to 30 weight percent of the second polycarbonate; and
0.1 to 10 weight percent of an additive composition.

14. A method of making the composition of claim 1, the method comprising:
melt-mixing the components of the composition.

15. An article comprising the composition of claim 1, preferably wherein the article is a housing for a consumer electronic component.
